(19) United States
(12) Patent Application Publication
(10) Pub. No.: US 2017/0352442 A1
(43) Pub. Date: Dec. 7, 2017

(54) Fuel Assembly For An SFR Nuclear Reactor, Comprising A Housing Containing A Removably Fastened Upper Neutron Shielding Device

(71) Applicant: COMMISSARIAT A L'ENERGIE ATOMIQUE ET AUX ENERGIES ALTERNATIVES, Paris (FR)

(72) Inventors: Denis Lorenzo, Manosque (FR); Thierry Beck, Pierrevert (FR); Guy Mailhe, Pierrevert (FR)

(21) Appl. No.: 15/536,421

(22) PCT Filed: Dec. 18, 2015
(86) PCT No.: PCT/EP2015/080460

§ 371 Date: Jun. 15, 2017

(30) Foreign Application Priority Data
Dec. 19, 2014 (FR) 1463003

(51) Int. Cl. G21C 19/105; G21C 13/06; G21C 3/335; G21C 19/20; G21C 3/334

(52) U.S. Cl. CPC G21C 19/105; G21C 19/207; G21C 3/334; G21C 3/335; G21C 13/06

(57) ABSTRACT

Fuel assembly for a nuclear reactor comprising a housing of longitudinal axis (X) having a central section containing nuclear-fuel pins and an upper section, forming a portion of the head of the assembly, containing a upper neutron shielding device (NSD) including neutron absorbers and means for reversibly interlocking with the housing and a moveable weight forming the head of the NSD, which is mounted so as to be able to move translationally relative to the rest of the NSD over a given path, said interlocking means being configured so that the NSD and the housing can be interlocked and uninterlocked by moving the moveable weight along the longitudinal axis by means of a grapple for extraction of the NSD, the claws of this grapple engaging with the moveable weight and the rest of the NSD being in downward longitudinal abutment in the interior of the housing.

### TECHNICAL FIELD

The present invention relates to a fuel assembly for fast neutron nuclear reactors cooled with liquid metal and in particular liquid sodium, i.e. what are called SFRs (sodium fast reactors), and that form part of the family of reactors called fourth-generation reactors.

The aim of the invention is firstly to provide a fuel assembly that may be used short-term in the fourth-generation reactor technology demonstrator project baptized ASTRID.

The fuel assemblies targeted by the invention may furthermore not only be used in an integrated-type nuclear reactor, i.e. in which the primary sodium circuit and its pumping means are completely enclosed in a vessel also containing heat exchangers, but also in a loop-type reactor, i.e. in which the intermediate heat exchangers and the means for pumping the primary sodium are located outside the vessel.

By fuel assembly, what is meant is an assembly comprising fuel elements and that is loaded and/or unloaded into/from a nuclear reactor.

By SFR fuel assembly, what is meant is a fuel assembly suitable for being irradiated in a fast neutron nuclear reactor cooled with liquid sodium i.e. what is called an SFR.

### PRIOR ART

Fuel assemblies intended to be used in fast neutron reactors cooled with liquid sodium (SFRs), include in their upper portion a neutron shielding device, usually designated by the expression “upper neutron shield” or by the acronym UNS. The reader may refer to the publication [1] (in French).

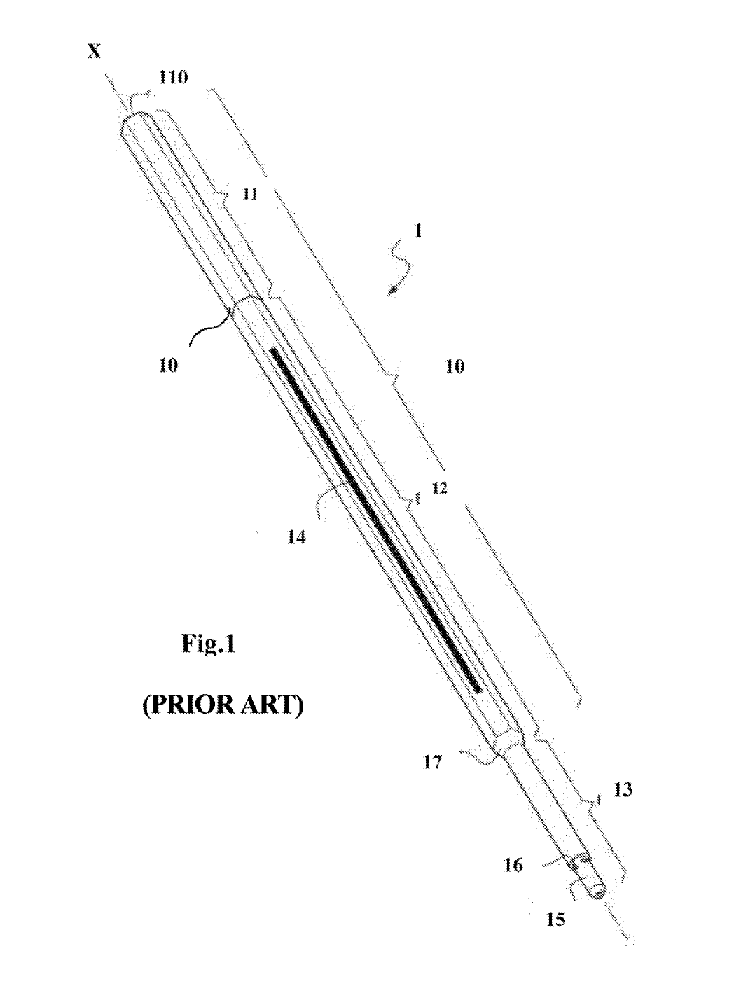

FIG. 1 shows a fuel assembly 1 that has already been used in the SFR nuclear reactor known by the name “Phénix”. Such an assembly 1, which is elongate along a longitudinal axis X, firstly comprises a tube or shroud 10 of hexagonal cross-section, the upper section 11 of which forms the head of the assembly, and which usually contains a UNS (not shown), and the central section 12 of which contains fuel rods (not shown). In other words, the sections 11, 12 form a single tubular wrapper 10 or shroud of identical hexagonal cross-section over its entire height. The head 11 of the assembly includes a central orifice 110 leading therein. The assembly 1 lastly comprises a lower section 13 forming the nose of the assembly, in the continuation of the shroud 10. The nose 13 of the assembly has a cone-shaped or rounded distal end 15 in order to be vertically insertable into the diagrid of a reactor core. The nose 13 of the assembly includes on its periphery orifices 16 leading therein.

Thus, when a fuel assembly is in its installed configuration, i.e. in position loaded into a reactor core, the nose 13 of the assembly 1, of male shape, is inserted into an orifice in the diagrid of the reactor and the assembly 1 is thus maintained in the latter with its longitudinal axis X vertical. The primary sodium may circulate through the interior of the assembly 1 and thus absorb via thermal conduction the heat given off by the fuel rods. The sodium is thus introduced via the orifices 16 in the nose 13 and exits via the central orifice 110 in the head 11, after having passed through the bundle of fuel rods.

As better illustrated in FIG. 1, the cross-section of the nose 13 of the assembly is smaller than the hexagonal cross-section of the shroud 10 of the assembly. The joint 17 between these two cross-sections 10, 13 forms a relatively rounded or conical shoulder so as to allow a sphere/cone-type joint to be formed with the diagrid of the reactor core.

The central section 12 of an assembly comprises a plurality of nuclear fuel rods. Each rod takes the form of a cladding in the interior of which is stacked a column 14 of pellets of fissile material, in which pellets the nuclear reactions that give off the heat take place. All the columns 14 define what is usually called the fissile zone and this zone is approximately located halfway up an assembly 1. It is schematically shown in the form of a black rectangle in FIG. 1.

UNSs, such as the one contained in the head 11, incorporate neutron absorbing materials in order to limit activation of the secondary sodium passing through the heat exchangers, to decrease radiation damage of the reactor plug structure usually called the “core cover plug (CCP)” and lastly to guarantee radiological protection of personnel located above the slab of the reactor.

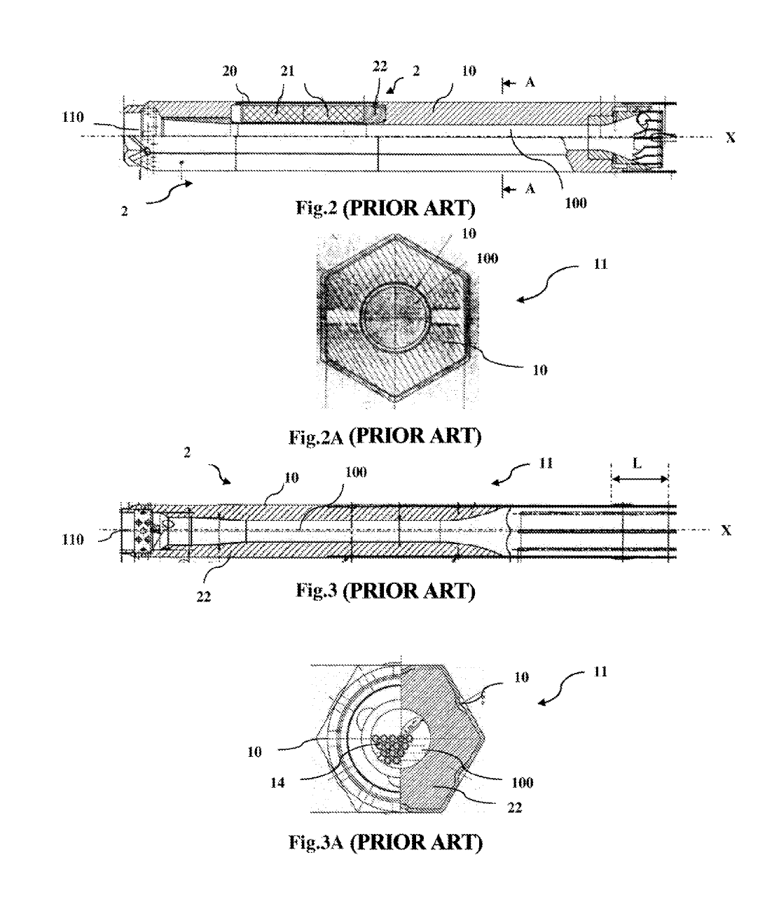

FIGS. 2 and 2A illustrate the UNS 2 integrated into the head 11 of the fuel assembly 1 used in the Phénix reactor. Such a UNS 2 consists of seal-tight tubular sleeves 20 into which blocks made of boron carbide 21 and blocks made of steel 22 are inserted, and, in the lower portion, a shroud 10 made of denser steel. Such a UNS 2 is demountably housed in the interior of the shroud 10 that defines the mechanical architecture of the fuel assembly. As may be seen in FIG. 2A, the shroud 10 defines in its center a passage 100 for the internal circulation of sodium.

FIGS. 3 and 3A illustrate the UNS 2 integrated into the head 11 of the fuel assembly 1 used in the SFR nuclear reactor known by the name “Superphénix”. Such a UNS 2 consists of a dense steel sleeve 20 joined to the hexagonal shroud 10. In this type of assembly 1, the fissile zone 14 includes, in its upper portion, a stack of depleted uranium oxide pellets, this stack being called the “upper axial blanket” (UAB), the function of which is to flatten the neutron flux and the length L of which is relatively large—about 300 mm.

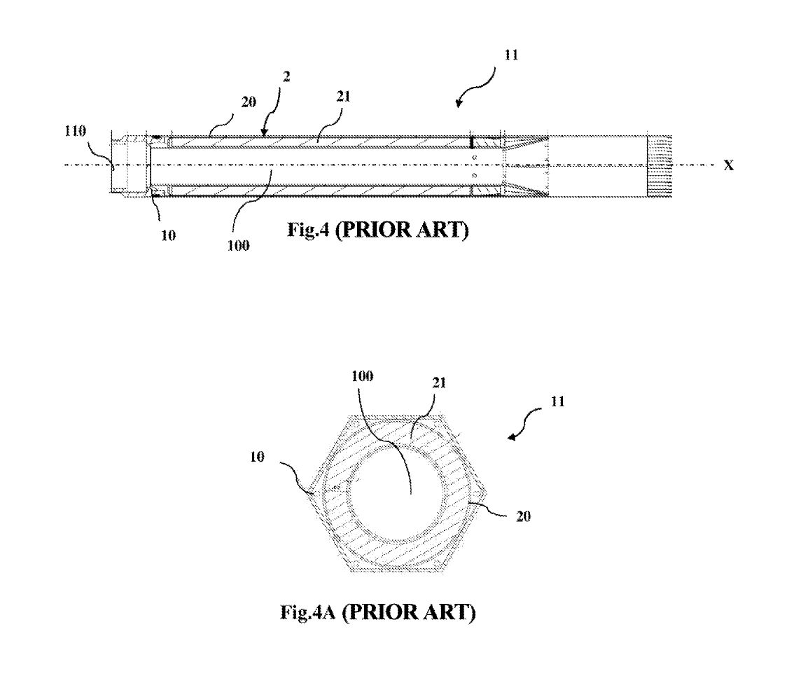

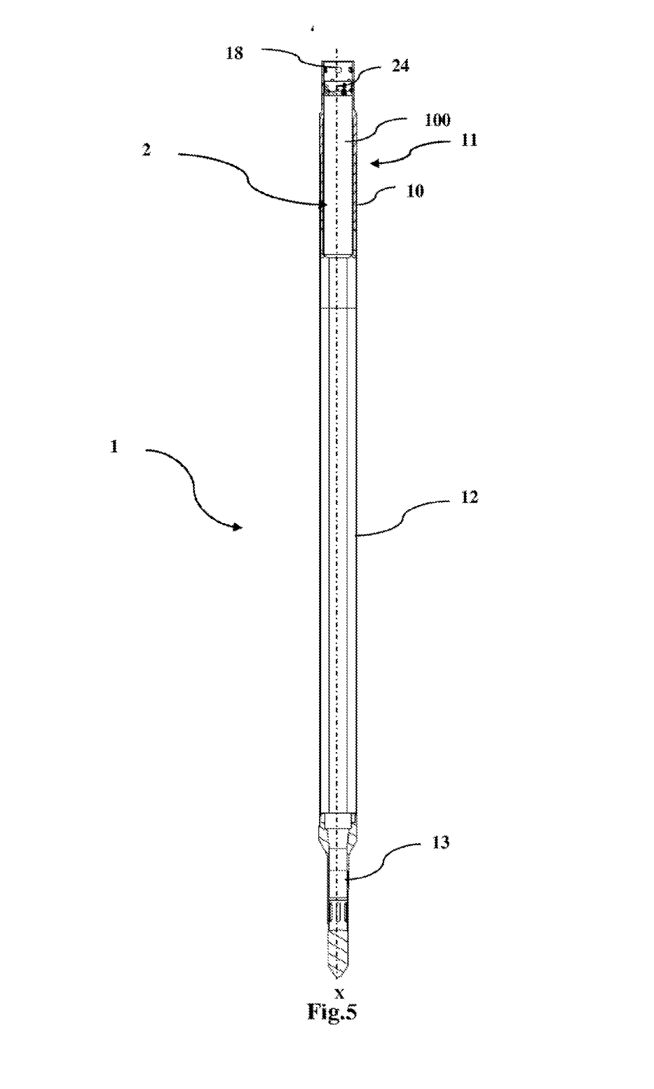

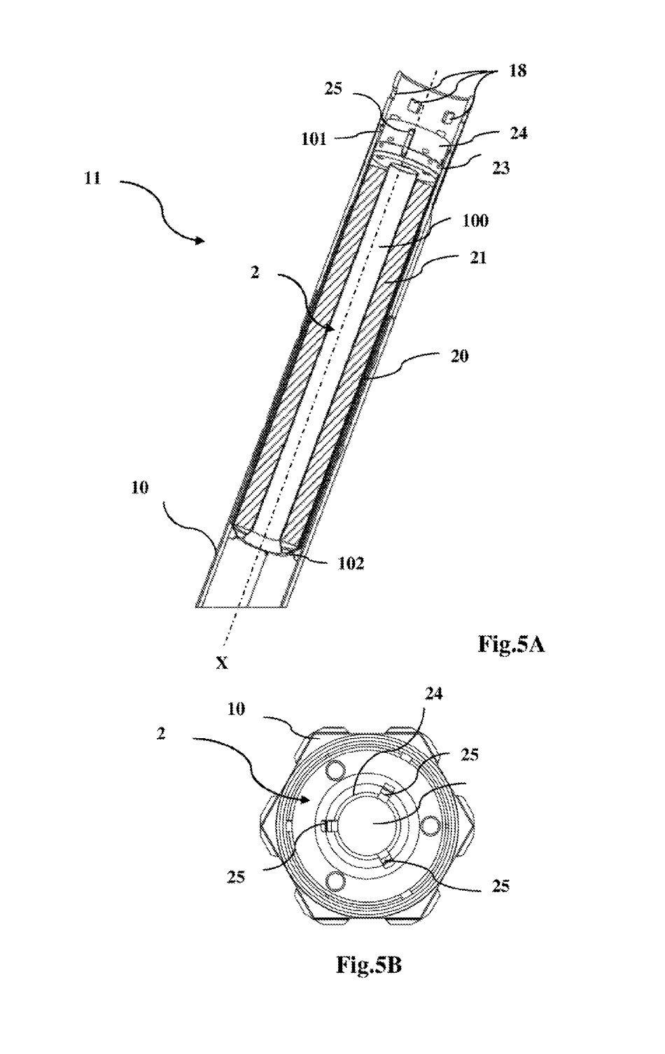

In the context of the various studies carried out regarding the design of the fuel assemblies 1 of the ASTRID reactor, the designers developed a preliminary fuel assembly version having a fixed UNS. A fuel assembly 1 according to this preliminary version is shown in FIGS. 4 and 4A: the UNS 2 consists of a non-seal-tight tubular sleeve 20 into which boron carbide 21 is inserted, the tubular sleeve 20 being fixedly housed in the wall of the hexagonal shroud 10. This UNS contains a sufficient amount of neutron absorbing material to meet the criterion set for the ASTRID fourth-generation reactor as regards activation of the secondary sodium.

In fact, there are three main radioprotection specifications for the UNSs of fuel assemblies intended to be used in the ASTRID reactor, namely:
limitation of the activation of the secondary sodium,
limitation of radiation damage to the core cover plug (CCP) structures,
radiological protection of personnel located above the slab of the reactor.

These main UNS specifications are on the whole valid for any type of reactor.

However, the configuration of the ASTRID reactor is particularly unaccommodating insofar as there is a minimum of neutron flux absorbing structures between the top of the fissile fuel and the bottom of the UNS, i.e. structures such as the UAB structures (of substantial length) of the fuel assembly used in the Superphénix reactor. Specifically, as will be explained below, the reason for this is related to the specification that the core have a low void coefficient (LVC), which requires there to be a volume (plenum) of sodium between the fuel rods and the bottom of the UNS, but also to the absence of fertile blanket in the upper portion of the fuel rods, which absence is in particular related to the specification that fourth-generation reactors be proliferation resistant.

In other words, the neutron fluence level seen by a UNS of a fuel assembly intended to be used in the ASTRID reactor is clearly higher than for any of the fuel assemblies used in prior SFR reactors i.e. fuel assemblies provided with a UAB structure and used in reactors the core of which was not LVC.

Under these conditions, the configuration of the Superphénix fuel assembly as illustrated in FIGS. 3 and 3A is unusable because the UNS 2, which is made of dense steel, would provide completely inadequate neutron shielding, unless the height of the UNS were greatly increased, which would be completely unacceptable for the height of the core of an ASTRID-type reactor.

In the ASTRID context, the UNS must furthermore meet a safety specification. It is a question of promoting the sodium void effect called the “plenum effect”, which is a characteristic of an LVC (low void coefficient) reactor core having a favorable response to transients and a negative sodium void coefficient. It will be recalled here that the void coefficient (expressed in dollars) expresses the change in the multiplication factor of the reactor when the coolant is no longer present in the core. If this coefficient is positive, voids result in an increase in the reactivity and in the power of the core. If it is negative, this effect will tend to stop the chain reaction. Dollar is a unit of reactivity. One dollar ($) corresponds to an increase in reactivity counted with respect to the delayed neutron fraction.

This safety specification is a priori completely new and has never been specified for any fast nuclear reactor ever operated or in operation. It necessarily requires absorbers made of boron carbide B₄C highly enriched in boron ¹⁰B to be used in the lower portion of the UNS, this definitively precluding a UNS made of dense steel such as the Superphénix UNS. This, combined with the high fluence level seen by this lower portion of the UNS, because of the absence of UAB as explained above, leads to a very large amount of helium being produced by the B₄C under irradiation.

The direct consequence of this is, for a seal-tight UNS design, the need to provide expansion vessels, i.e. free volumes allowing the gas produced to be accommodated, of about 800 mm height for pressures of about 100 bars. However, such expansion vessels are unacceptable both in terms of bulk and in terms of safety. Thus, increasing the height of a core by one meter in particular implies increasing the height of the vessel by two meters, leading to a significant increase in the required initial investment. Furthermore, if there was a loss of containment of the substantial volumes of gas stored in the expansion vessels, there would then be a risk of rapid transients in core power.

For all these reasons, the seal-tight UNS design for example used in fuel assemblies for the Phénix reactor i.e. such as illustrated in FIGS. 2 and 2A, are unusable in an ASTRID fuel assembly.

Lastly, a UNS must meet specifications relating to the first step of dismantling the assembly. On the one hand this step must allow the neutron absorbing elements and the nuclear fuel elements to be treated separately, and on the other hand it must be compatible with the water storage and washing processes to which assemblies are subject after irradiation.

These two specifications are not new, but will probably be of greater importance for the fuel assemblies of fourth-generation reactors such as ASTRID than was the case for those of previous fast neutron reactors.

Specifically, if reference is made to the fuel assemblies of the Phénix and Superphénix reactors, i.e. the assemblies illustrated in FIGS. 2 and 3, respectively, the UNSs were undemountably housed in the shrouds of the fuel assemblies. When these known assemblies were dismantled, it is necessary to chop up the irradiated assembly, this being an onerous cutting operation that is very difficult to automate and that requires specific cells and pieces of equipment and very expensive additional storage spaces.

Thus, for a fourth-generation reactor such as ASTRID, the inventors have arrived at the conclusion that it would be better to develop an easily demountable connection between the UNS and the rest of the fuel assembly in order to allow the UNS to be extracted by a handling gripper-type device. Moreover, it would be better if the UNS were demountable in sodium or in gas, before the washing operations proceeding water storage of the fuel assembly, these operations not being envisionable at the current time for a non-seal-tight UNS formed from absorbing elements made of B₄C.

Specifically, none of the sodium-removing technologies studied up to now in R&D have given any reason to believe that it will be possible to obtain complete and effective sodium removal on an industrial scale, this being incompatible with pool storage such as provided for in the ASTRID reactor. The presence of residual sodium in the UNS after washing, and more precisely in the play between the neutron absorbers and cladding, means that there is a risk of unexpected and uncontrolled reaction between the sodium and the water if the assemblies are stored in water long-term.

Therefore, for a non-seal-tight UNS it is necessary for it to be possible to detach the UNS from the rest of the fuel assembly before the washing operation. This requirement that the UNS be demountable before washing is valid independently of whether the storage solution finally used to store the irradiated assemblies is an internal or external solution. In case of an external storage solution, a storage drum of the type implemented in the Phénix or Superphénix reactors would be the ideal place to demount the UNS, this operation then being carried out on-line under sodium, not requiring additional expensive equipment and being without impact on the level of availability of the reactor since the demounting operation may be carried out while the reactor is in operation. In case of an internal storage solution, it would be necessary to be able to demount the UNS under a gas atmosphere on-line in the handling flasks for handling the assemblies.

In light of all the functional specifications described above, the inventors have arrived at the conclusion that an ASTRID fourth-generation SFR reactor fuel assembly must meet the following design criteria:
there must be a demountable mechanical connection between the UNS and the rest of the assembly so as to allow the UNS to be extracted from the assembly on-line before the washing operation, whether in a sodium-cooled storage drum or in a gas-cooled handling flask provided for this purpose;
the fraction per unit area of B₄C neutron absorbers must be similar to that of the non-demountable UNS of the preliminary fuel assembly version shown in FIGS. 4 and 4A, and must favor the aforementioned plenum effect without significantly increasing the height of the UNS and therefore the height of the assemblies of the reactor core;
the axial extent of the means for securing the UNS to the rest of the assembly must be minimized in order not to significantly increase the height of the UNS and therefore the height of the assemblies of the reactor core.

Furthermore, the demountable mechanical connection must:
allow a fuel assembly to be handled with the same type of gripper, whether the assembly is or is not equipped with the UNS, in a handling flask or in a storage drum;
be robust, i.e. it must have a low risk of failure, both with respect to untimely deactivation in a reactor (at the risk in particular of being dropped onto the bundle of fuel rods, which is obviously not desirable in terms of safety) and with respect to jamming/seizure during the extraction with a gripper (which would decrease the level of availability of the reactor).

The inventors have thus sought to identify from known reversible fastening solutions already used in nuclear reactor vessels those that could be used to demountably connect a UNS to the rest of a fuel assembly in the ASTRID fourth-generation SFR reactor.

The known solutions may be grouped into two categories.

The first of these categories pertains to ways of demountably connecting a UNS and a nuclear assembly.

Thus, patent FR2402923 discloses a fuel assembly for a nuclear reactor, in particular an SFR reactor, comprising an assembly head that also incorporates a dense steel UNS that is securely and reversibly fastened to the rest of the assembly either by means of a system of pins that are located transverse to the longitudinal axis of the assembly or by means of a bayonet system. An assembly according to patent FR2402923 is incompatible with the functional specifications given above for a number of reasons. Firstly, the handling head of the assembly is integral with the UNS and thus the assembly cannot be handled with the same gripper whether it is or is not equipped with its UNS. In addition, the pin-based or bayonet connecting system must bear the weight of the assembly during handling, this creating a safety risk that is very hard to accept, namely the risk that the connection will break. Lastly, the UNS cannot be demounted on-line and it is impossible to handle the rest of the assembly once the UNS-head assembly has been removed.

Patent FR 2513797 also discloses a fuel assembly for a nuclear reactor, in particular for a fast neutron reactor, with a demountable UNS. The disclosed UNS consists of a cylindrical capsule containing the neutron absorbing material and held in the center of the assembly by three plates arranged at 120°, the upper portion of these plates forming a head for gripping the assembly, these plates each being fastened to the body of the assembly by welded pins, by embedded and welded profiled corners or by welded clasps. An assembly according to patent FR 2513797 has the same incompatibilities with the functional specifications for an ASTRID fourth-generation SFR reactor fuel assembly as an assembly according to patent FR 2402923. Furthermore, the capsule disclosed in this document, i.e. the capsule containing the neutron absorbing material, is seal-tight and would require, under the operating conditions of the ASTRID fourth-generation SFR reactor, expansion vessels that would be very disadvantageous with respect to the height of the assembly and to the safety of the core.

U.S. Pat. No. 4,935,197 also discloses a fuel assembly for a nuclear reactor, with a demountable UNS. The disclosed UNS consists of a bundle of rods of neutron absorbers that is fastened by screw threaded connections or by bayonet-type connections to the head of the fuel assembly, which head is itself fastened by screw threaded connections to the shroud, which is of hexagonal cross-section. Again, an assembly according to U.S. Pat. No. 4,935,197 has the same incompatibilities with the functional specifications for an ASTRID fourth-generation SFR reactor fuel assembly as an assembly according to patents FR 2402923 and FR 2513797. In particular, it is completely unenvisionable to demount or remount on-line the screw threaded connections that are disclosed. Moreover, even if these unscrewing and screwing operations were carried out in a handling flask, the inventors think that it would not actually be possible to ensure the reliability of these connections in a liquid-sodium-cooled reactor environment because of the multiple sources of deformation, of mechanical damage and of seizures after a long reactor stay, such as irradiation swelling, creep, irradiation embrittlement, the mechanical loads applied to the head during handling operations, the sodium environment, etc. This lack of reliability also goes for a bayonet connection between the assembly head and the shroud, because it is very hard to believe that this type of mechanical connection could reliably bear the load of the fuel assembly during handling.

In summary, the known solutions in the demountable UNS connections category are not suitable for the link between a UNS and the rest of an ASTRID fourth-generation SFR reactor fuel assembly, essentially for the following reasons:
known connections are not demountable on-line;
the fuel assemblies are necessarily handled via the UNS: the handling head of the assembly is extracted at the same time as the UNS, this meaning that it is no longer possible to handle the assembly with the same gripper after the UNS has been extracted. The known connections between the UNS and the assembly must therefore bear the weight of the assembly during handling, this creating a risk that is very hard to accept in terms of safety, namely the risk that the connection will break during handling.

The second category pertains to locking/unlocking solutions used in other removable devices found in nuclear reactor vessels.

Patent EP 0312416 discloses a way of reversibly fastening a (pressure reducing) flow regulating device that is located in the head of a fuel assembly for a fast neutron reactor, the device being demountable on-line with the gripper for handling the assembly. This patent moreover describes a locking system consisting of pivoting fingers that are made to pivot, indirectly, by the vertical translation of the gripper. Again, the solution proposed in Patent EP 0312416 does not allow the functional specifications (described above) for an ASTRID fourth-generation SFR reactor fuel assembly to be met. Specifically, the disclosed locking system firstly has too great an axial extent and the internal shoulder required in the assembly head implies too great a decrease in radial cross-section. Furthermore, the disclosed system under no circumstances allows the locking fingers to be mechanically forced in case of seizure. Lastly, the pressure reducing device disclosed is handled by the same gripper as that used to handle the assemblies and it is impossible to handle the assembly without having previously removed the pressure reducing device, this being incompatible with the level of availability expected for an industrial nuclear reactor. These two last points would prevent even probable use in a fast nuclear reactor.

Patent BE558245 discloses a solution for removably fastening a fuel element in a vertical channel of a UNGG reactor, with a system of pivoting fingers that are made to pivot, relatively directly, by a gripper and that allows the fuel element to be locked in place. Again, the solution disclosed in patent BE558245 has the same incompatibilities with the functional specifications for an ASTRID fourth-generation SFR reactor fuel assembly. In particular, the lock achieved by the pivoting motion of the fingers is provided only to prevent the fuel element from falling under gravity, i.e. to block a downward axial translation. In other words, this lock does not allow ejection of a device, such as a removable UNS, under the drag force exerted by a coolant to be prevented. Moreover, in this patent, the return of the pivoting fingers is ensured by a spring, such a solution having no place in a fast neutron reactor because it is not considered to be reliable, because of the risk of the elastic properties of the spring changing under irradiation.

Patent application EP 2741298 A1 discloses a system for gripping and locking/unlocking a holder of samples of nuclear materials in an instrument holder for experimental irradiations, the two main objectives of this system being to provide a handling gripper comprising no moving parts and to ensure a seal-tight lock of the sample holder to the gripper. To do this, the locking/unlocking system disclosed implements many small movable parts describing a precise and fairly complex movement that, combined with the seal-tight lock objective, requires tight fits. This system is not adapted to the on-line handling of heavy parts such as a UNS of a fuel assembly for a technology demonstrator such as ASTRID. Moreover, the locking/unlocking system includes a return spring for returning these parts, which has no place in a fast neutron reactor, as for patent BE558245.

In summary, just like the known demountable UNS connections, the known locking systems of removable reactor devices analyzed above would not allow the specifications for the connection between a UNS and the rest of an ASTRID fourth-generation SFR reactor fuel assembly to be correctly met.

There is therefore a need to improve the demountable connection of a UNS to a fuel assembly, in particular in order to meet the specifications for the connection between a UNS and the rest of an ASTRID fourth-generation SFR reactor fuel assembly.

The aim of the invention is to at least partially meet this need.

### SUMMARY OF THE INVENTION

To this end, one subject of the invention is a fuel assembly for nuclear reactor, in particular for a sodium-coded SFR reactor, including a shroud of longitudinal axis (X) intended to be inserted vertically into the diagrid of the core of the reactor, the shroud comprising a central section housing nuclear fuel rods and an upper section forming a portion of the head of the assembly housing an upper neutron shield (UNS) device including neutron absorbers and means for reversibly locking with the shroud and a weight forming the head of the UNS, said weight being translationally movable with respect to the rest of the UNS over a given course, said locking means being configured so that the UNS and the shroud can be locked and unlocked by moving the weight along the longitudinal axis by means of a UNS-extracting gripper with the fingers of this gripper hooked into the weight and the rest of the UNS being in downward longitudinal abutment in the interior of the shroud.

According to one advantageous embodiment, the head of the assembly furthermore including holes or a groove that is or are suitable for interacting with the fingers of a handling gripper in order to allow the assembly to be handled whether it is or is not equipped with its UNS, the gripper for handling the assembly having the same operating movement as that of the UNS-extracting gripper.

The fuel assembly such as defined allows the specifications for the connection between a UNS and the rest of an ASTRID fourth-generation SFR reactor fuel assembly to be met.

To arrive at the definition of the invention, the inventors made the following analysis.

To increase and reach a fraction per unit area of neutron absorbing material of the same order as that of a non-demountable sleeve-type UNS, such as that of the preliminary version illustrated in FIGS. 4 and 4A, it would appear necessary above all to maximize the outside diameter of the UNS in order that it be as close as possible to the inside diameter of the shroud of hexagonal cross-section.

However, in the case of a removable UNS extracted via the assembly head, the decrease in the inside diameter of the assembly head, which is used for gripping by the handling gripper, in fact limits the outside diameter of the UNS. This loss in diameter would be compensable only by a very significant increase in the height of the UNS.

Furthermore, a solution that would consist in fastening the UNS to the assembly head and in deploying a demountable mechanical connection between the assembly head and the hexagonal shroud, i.e. defining a demountable assembly head is not desirable, essentially for the following reasons:
all the stresses of handling the assembly would then transit via this connection, and hence it would be a source of risk, which would be very hard to accept, in case of failure of the connection during the phase of handling the fuel assembly above the core, both in terms of safety (endangerment of the mechanical integrity of the core) and availability (organization of very time-consuming exceptional interventions);
such a design would only be able to meet with difficulty the specification that the assembly be handleable with the same gripper whether it is or is not equipped with its UNS. Specifically, it would be necessary either to be able to mount a new handling head after extraction of the assembly, which would a priori seem complicated insofar as it would then be necessary to have available a reserve of a plurality of heads during each handling campaign, this being unenvisionable in any case for an internal storage solution in which these operations would have to be carried out on-line in a handling flask; or to provide a second gripping interface in the assembly wall above the assembly head, which would lead to a clear complexification of the manufacture of the assembly, or even to an incompatibility with certain specifications, such as the specification that steel structures be absent from the zone above the fuel rods in order to promote the plenum effect.

The inventors therefore arrived at the conclusion that it was necessary:
to define a new interface for gripping the assembly during handling in order to provide an extractable UNS of outside diameter close to the inside diameter of the shroud of hexagonal cross-section;
to define for the UNS new clasping and locking means having an axial extent of the second order with respect to the height of neutron absorbing material necessary, i.e. an extent of about ten centimeters in the context of a reactor such as ASTRID.

The means for reversibly locking the UNS to the assembly head according to the invention have a small axial extent. Thus, the production of the removable UNS has no impact on the height of the fuel assembly.

In addition, with respect to the sleeve of the non-demountable UNS such as envisioned in the preliminary version for the ASTRID nuclear reactor, and illustrated in FIGS. 4 and 4A, the inventors have been able to decrease the inside diameter of the sleeve of the demountable UNS according to the invention without significantly increasing pressure losses.

Lastly, by virtue of the assembly head structure with holes or groove for its handling, it is advantageously possible to increase the outside diameter of the removable UNS in order to make it closer to that of a non-demountable UNS such as that illustrated in FIGS. 4 and 4A.

With a small axial extent of the locking means, a small UNS inside sleeve or wrapper diameter and a large outside diameter of the latter, it is possible to increase the volume of neutron absorbing material within the removable UNS, with respect to a non-demountable UNS according to the prior art. The inventors have shown that it is possible to reach a volume of neutron absorbing material substantially equivalent to that of the non-demountable UNS such as envisioned in the preliminary version for the ASTRID nuclear reactor.

According to one advantageous feature, the UNS head may include a part forming a plug of the neutron absorbers of the UNS and supporting the locking means.

According to one advantageous embodiment, the locking means consist of fingers that are mounted so as to be able to pivot in a vertical plane. According to this embodiment, each of the fingers is preferably mounted so as to be able to pivot about a pivot pin fastened to the plug.

According to one advantageous variant, the weight includes fixed pins that are each suitable for sliding in the interior of a slot in a pivoting finger, a vertical translational movement of the weight causing the pins to slide in the slots and thus the fingers to pivot.

The weight preferably includes an interior groove into which the fingers of the UNS-extracting gripper may be hooked.

Also preferably, the shroud of the assembly includes an interior groove into which the fingers of the locking means may insert to form an upper stop for the UNS.

Advantageously, the UNS is not seal-tight.

According to one variant embodiment, the UNS includes one or more hollow columns that is or are fastened to the plug and that pass through the weight, the one or more columns being suitable for being brought to bear against a translationally movable part of the extracting gripper, in order to create an ascendant relative movement between the weight and the rest of the UNS during the unlocking operation. These columns allow the sodium to flow through the UNS and the helium generated under irradiation to be freed (non-seal-tight UNS design).

Alternatively, the UNS includes a ferrule that is exterior to the plug, the ferrule being suitable for being brought to bear against a translationally movable part of the gripper in order to create an ascendant relative movement between the weight and the rest of the UNS during the unlocking operation.

Instead of a seal-tight UNS, a seal-tight UNS may be envisioned, in particular for reactors in which the volumes of gas generated under irradiation by the neutron absorbing material would be zero or low, which would be the case for any one of the following conditions:
an absence of use of highly enriched B₄C at the bottom of the UNS, typically in case of absence of specification for the LVC effect,
or clearly lower neutron fluxes level with the UNS, typically in case of presence of an upper axial blanket above the fissile fuel,
or the use of a material other than B₄C and not including ¹⁰B, typically in case of conditions of clearly lower flux level with the UNS.

According to one variant embodiment, the UNS includes a sleeve housing and supporting blocks of neutron absorber, and a plug fastened to the top of the sleeve.

Alternatively, the UNS includes a wrapper housing rods of neutron absorber, and a plug fastened to the top of the wrapper and supporting these rods. Instead of the wrapper, grids for maintaining the rods could be envisioned.

The assembly preferably includes a part fastened to the interior of the shroud, forming the lower axial stop at the bottom of the UNS.

The neutron absorbers placed in the UNS may be chosen from boron carbide (B₄C), hafnium (Hf), hafnium diboride (HfB₂), titanium diboride (TiB₂), ferroboride (FeB), uranium dioxide (UO₂), the rare earths.

Preferably helium producing neutron absorbers, such as B₄C (boron carbide), HfB₂ (hafnium diboride), TiB₂ (titanium diboride), FeB (ferroborride) are used in a non-seal-tight UNS.

Also preferably, neutron absorbers that do not produce helium, such as uranium dioxide (UO₂), hafnium (Hf), the rare earths are used in a seal-tight UNS.

Another subject of the invention is a method for handling a fuel assembly whether it is or is not equipped with its UNS described above, wherein a handling gripper that is of the same type as, of the same type as, and preferably identical to, that used for the extraction of the UNS is used.

Another subject of the invention is a method for equipping a new fuel assembly not equipped with a UNS, with an irradiated UNS extracted from an irradiated fuel assembly described above.

The invention also relates to the use of a fuel assembly such as described above in a fast neutron nuclear reactor. The reactor may be a liquid-metal- or gas-cooled reactor, the liquid metal being chosen from sodium, lead or lead-bismuth.

### DETAILED DESCRIPTION

Other advantages and features of the invention will become more clearly apparent on reading the detailed description of the invention given by way of nonlimiting illustration with reference to the following figures, in which:

FIG. 1 is an external perspective view of a fuel assembly according to the prior art, already used in a sodium-cooled SFR nuclear reactor;

FIG. 2 is a longitudinal semi-cross-sectional view of the head of a fuel assembly according to the prior art showing the upper neutron shield (UNS) device, which has already been used in the “Phénix” nuclear reactor;

FIG. 2A is a transverse cross-sectional view of the UNS of the assembly in FIG. 2;

FIG. 3 is a longitudinal cross-sectional view of the head of a fuel assembly according to the prior art showing the upper neutron shield (UNS) device, which has already been used in the “Superphénix” nuclear reactor;

FIG. 3A is a transverse semi-cross-sectional view of the UNS of the assembly in FIG. 3;

FIG. 4 is a longitudinal cross-sectional view of the head of a fuel assembly according to the prior art showing the upper neutron shield (UNS) device, which was the preliminary version envisioned for the “ASTRID” nuclear reactor;

FIG. 4A is a transverse cross-sectional view of the UNS of the assembly in FIG. 4;

FIG. 5 is a partial longitudinal cross-sectional view of an exemplary fuel assembly according to the invention showing the upper neutron shield (UNS) device, which is intended to be used in the “ASTRID” nuclear reactor;

FIG. 5A is a partial longitudinal cross-sectional view of the assembly head in FIG. 5;

FIG. 5B is a top view of the assembly head in FIG. 5;

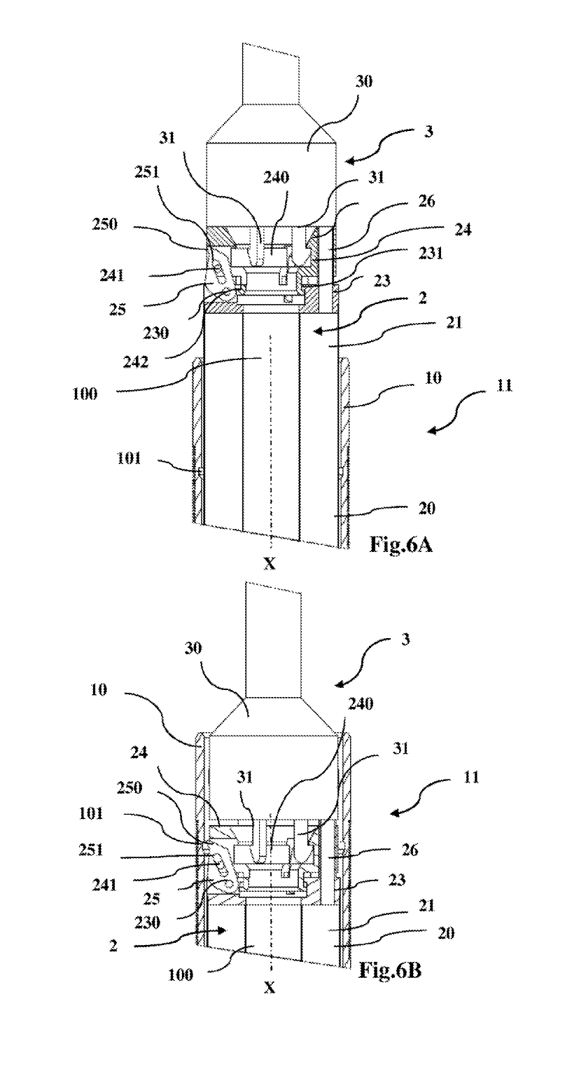

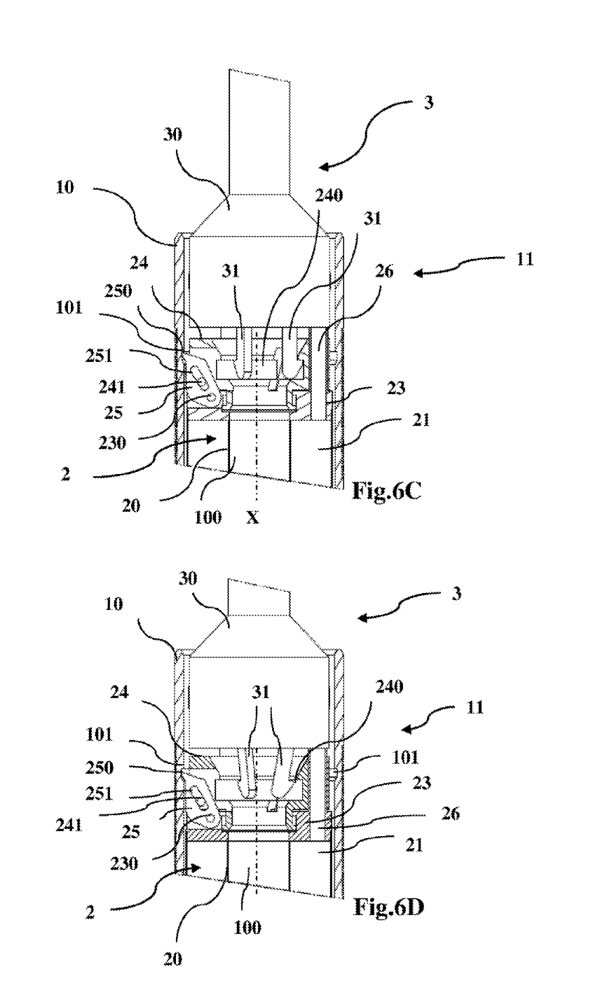

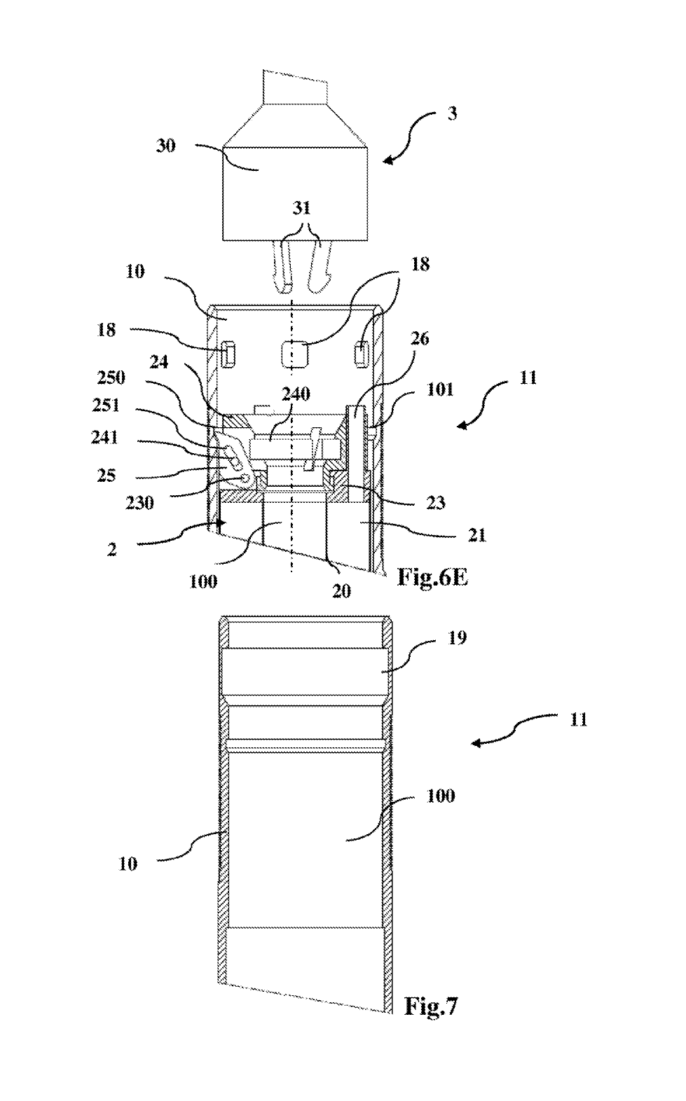

FIGS. 6A to 6E are partial longitudinal cross-sectional views illustrating various steps of handling, of inserting and of locking a UNS in an exemplary fuel assembly according to the invention such as shown in FIGS. 5 to 5B;

FIG. 7 is a longitudinal cross-sectional view level with the head of a variant of the shroud of a fuel assembly according to the invention;

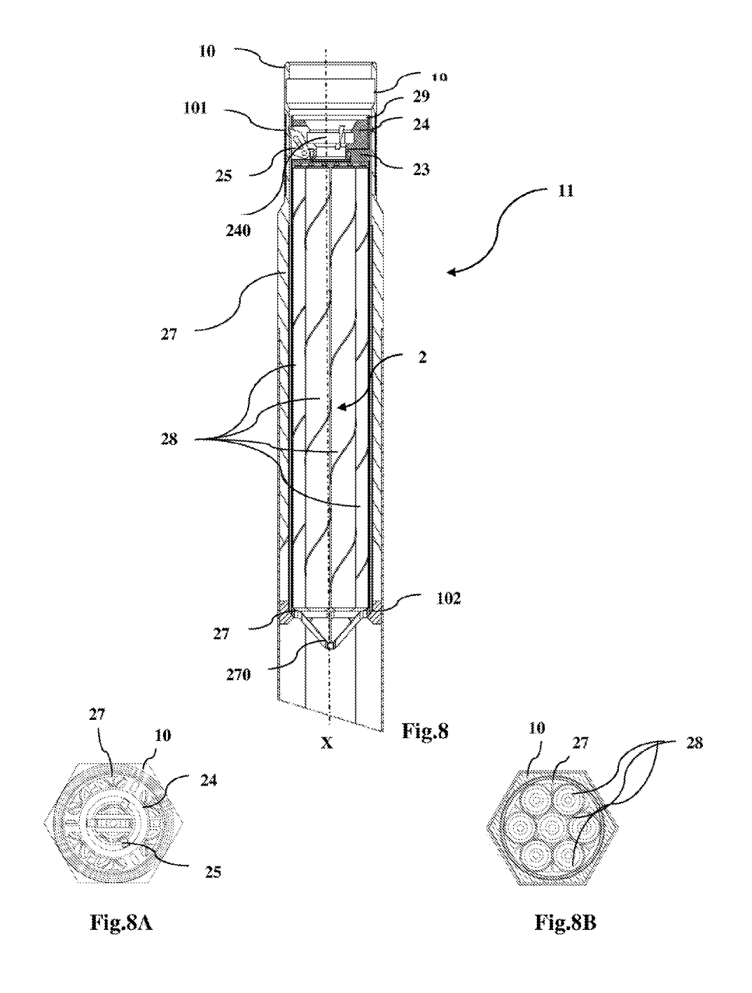

FIG. 8 is a partial longitudinal cross-sectional view of another exemplary fuel assembly head according to the invention showing the upper neutron shield (UNS) device, which is intended to be used in the “ASTRID” nuclear reactor;

FIG. 8A is a top view of the assembly head in FIG. 8 showing the arrangement of the gripping head of the UNS;

FIG. 8B is a transverse cross-sectional view of the UNS in FIG. 8 showing the arrangement of the absorbing elements of the UNS;

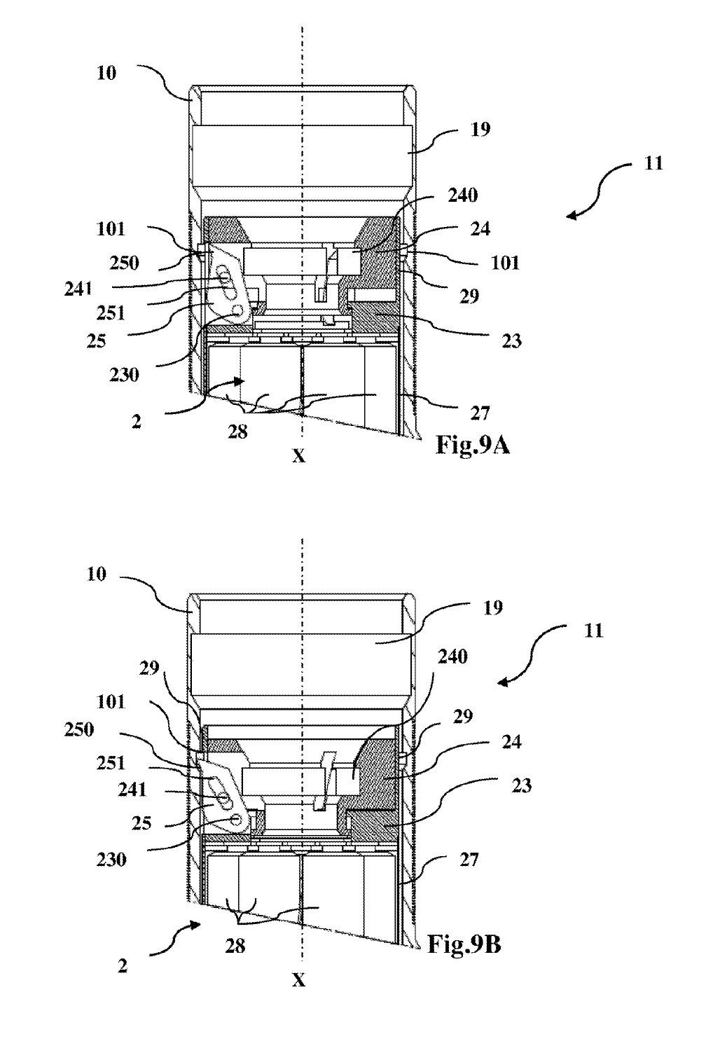

FIGS. 9A and 9B are partial longitudinal cross-sectional views illustrating two steps of locking and unlocking a UNS in another exemplary fuel assembly according to the invention such as shown in FIGS. 8 to 8B.

For the sake of clarity, in FIGS. 1 to 9B the same references have been used to refer to the same elements of the fuel assembly and elements of the upper neutron shield (UNS) devices independently of whether they are according to the prior art or according to the invention.

Throughout the present application, the terms “vertical”, “lower”, “upper”, “bottom”, “top”, “below” and “above” are to be understood to be with reference to a fuel assembly such as it is in its vertical configuration in a nuclear reactor.

FIGS. 1 to 4A, which relate to the prior art, have already been described in detail in the preamble and are therefore not commented on below.

Now, with reference to FIG. 5, a fuel assembly 1 according to the invention, such as it is intended to be used in an ASTRID SFR nuclear reactor, will now be described. Just as for the fuel assemblies according to the prior art that were intended for fast neutron reactors, the assembly 1 according to the invention is elongate along a longitudinal axis X and comprises a shroud 10 of hexagonal cross-section, the upper section 11 of which forms the head of the assembly, and which contains a neutron shield device 2 called the UNS. The central section 12 of the assembly 1 contains fuel rods (not shown).

Lastly, the assembly 1 comprises a lower section 13 forming the nose of the assembly, in the continuation of the shroud 10. The nose 13 of the assembly has a cone-shaped or rounded distal end in order to be able to be inserted vertically into the diagrid of a reactor core. The nose 13 of the assembly also includes on its periphery orifices leading therein for the circulation of sodium in the interior of the assembly.

The head 11 of the assembly includes within it an interior passage 100 left free by the UNS 2 and that leads to a central orifice 110 that itself leads toward the exterior (FIGS. 5 and 5A). The head 11 of the assembly also includes a continuous interior groove 110 produced in the shroud 10 and a lower supporting part 102 fastened to the interior of the shroud 10.

Such as illustrated in FIGS. 5 to 6E, the head 11 of the assembly according to the invention includes holes 18 that are regularly distributed angularly and that are each suitable for interacting with a finger of a gripper for handling the assembly as explained below.

Such as illustrated in FIGS. 5 to 6E, the UNS 2 according to the invention includes a sleeve 20 housing blocks 21 of boron carbide B₄C, by way of neutron absorbing materials.

The UNS 2 also includes a plug 23 fastened to the top of the sleeve 20 and that maintains the blocks 21 in the latter.

The UNS 2 also includes above the plug 23, a weight 24 forming the head of the UNS. The weight 24 is mounted so as to be free to move translationally with respect to the plug 23 but only over a given course, stops internal to the plug 23 and to the weight 24, formed by shoulders 231, 242, mutually interacting to maintain them together once the course has been travelled. The weight 24 has a continuous interior groove 240 that is suitable for interacting with the fingers of a UNS-extracting gripper 3 as explained below. The weight 24 lastly incorporates three fixed pins 241.

The head of the UNS 2 also includes locking fingers 25 that are mounted so as to be able to pivot about a fixed pivot pin 230 of the plug 23 in such a way that the fingers 25 pivot in vertical planes. As illustrated in FIG. 5B, the locking fingers 25 are three in number and distributed at 120° from one another. It goes without saying that the number of fingers 25 may be different, though they will preferably still be regularly distributed angularly around the periphery of the crown 24. Each of the fingers 25 includes a locking end 250 that is suitable for interacting with a continuous interior groove 110 produced in the shroud 10, and a through-slot 251 that is of oblong shape in the illustrated example.

According to the invention, the fact that the weight is mounted so as to be free to move translationally allows, when the weight 24 is moved toward the plug 23, each fixed pin 241 to slide in the interior of a slot 251 thereby causing a finger 25 to pivot in a vertical plane and toward the exterior of the UNS 2 and thus the finger 25 to be inserted into the interior groove 101 of the shroud 10, as detailed below. The weight 24, which then rests on the fingers 25 by way of the pins 241, prevents them from pivoting toward the interior of the UNS and locks them in position in the groove 101.

Thus, when the UNS 2 is in its locked position in a fuel assembly 1, i.e. when it is such as illustrated in FIGS. 5, 5A, 5B, 6C, 6D, 6E, 8, 8A, 8B and 9B, the lower portion of the UNS 2, i.e. the bottom of the sleeve 20, is supported by the supporting part 102 that is fastened to the interior of the shroud 10, thereby making it possible to ensure the UNS 2 is held laterally and that any downward translational movement is blocked, and the upper portion of the UNS 2 is locked in place, i.e. by its weight 24, via the insertion of the fingers 25 into the groove 101 of the assembly head 11, this making it possible to ensure any upward translational movement is blocked.

Advantageously, one or more hollow columns 26 is or are arranged and fastened to the plug 23 and also pass through the weight 24 (FIGS. 6A to 6E). Preferably, these columns 26 are three in number and distributed at 120° from one another. It goes without saying that the number of columns 26 may be different, though they are preferably regularly distributed angularly around the periphery of the plug 23. In the extreme position of separation of the plug 23 and the weight 24, as illustrated in FIG. 6A, the one or more columns protrude from the latter.

Each of these hollow columns 26 has the following functions:
it forms a slide-connection between the plug 23 and the weight 24, in order to give a maximum robustness to the relative translational movement between these two components;
it forms a vent allowing the sleeve 20 to be filled with sodium and helium to exit from the sleeve;
it allows the head 30 of an extracting gripper 3 described below to mechanically force the fingers 25 to pivot during the operation of unlocking the UNS.

It will be noted here that in the context of the invention the expression “extracting gripper” is used to designate the gripper 3 used to grip the UNS 2 by way of the weight 24, because this gripper is not intended to be used to insert the UNS 2 into the rest of the assembly in the reactor vessel. In other words, the gripper 3 is not intended to be used in a reactor vessel for this inserting operation.

Thus, when the UNS 2 is to be unlocked from the assembly head 11, the head 30 of the gripper 3 is brought to bear against each column 26 in order to create a relative ascending movement between the weight 24 and the rest of the UNS 2, and therefore mechanical seizure effects that are liable to be seen after a stay in sodium are mitigated. In other words, by virtue of these columns 26, it is possible to ensure the UNS may be reliably unlocked even in case of mechanical seizure.

All of the locking/unlocking means described are designed to minimize the risk of mechanical seizure. All the movements of the various means require no precise fits and there may be large amounts of play between all the parts. The function allowing an eventual seizure to be forced via the columns 26 allows the robustness of the unlocking assembly to be improved, and therefore on-line extraction of the UNS from its assembly to be guaranteed and hence the level of availability of the nuclear reactor containing the assemblies according to the invention to be guaranteed.

With reference to FIGS. 6A to 6E, the steps of lowering, of inserting and of locking the UNS 2 into the fuel assembly 1 will now be described in chronological order, these steps being carried out by means of the extracting gripper 3.

It will be noted that, as already mentioned, the gripper is not intended to be used to insert the UNS 2 into the fuel assembly 1 while it is in the ASTRID reactor, but rather to be used during mounting operations carried out outside the vessel. Nevertheless, the insertion of the UNS into the assembly with the extracting gripper 3 is described in order to describe the operation of the locking/unlocking means. Furthermore, this inserting operation may take place outside the reactor vessel, in particular in the external storage barrel, and it is the inverse of the extracting operation.

The extracting gripper 3 grips the UNS 2 by the weight 24 of the UNS. The extracting gripper 3 includes a head 30 in which gripping fingers 31 are mounted so as to be able to pivot in a vertical plane, and the head 30 of the gripper is mounted so as to be free to move translationally with respect to the fingers 31. Insertion of the fingers 31 in the interior groove 240 of the weight 24 allows it to be gripped and the fact that the head 3 is mounted so as to be free to move translationally with respect to the rest of the gripper 3 allows, when the UNS 2 is held by the fingers 31, a relative axial movement to be created between the weight 24 and the plug 23.

A phase of approach and insertion is first carried out in which the gripper 3 inserts the UNS 2 into the assembly 1 along its longitudinal axis X (FIG. 6A) until the bottom of the sleeve 20 makes contact with the supporting part 102 that is fastened to the shroud (FIGS. 5A and 6B).

The vertically downward translational movement of the head 30, which is free to move translationally, of the gripper 3 is continued, thus creating a relative axial movement between the weight 24 and the plug 23. The stops, formed by the lower shoulder of the weight 24 and the upper shoulder of the plug 23, respectively, then move further apart. Moreover, the downward vertical translational movement of the weight 24 causes the fingers 25 to pivot toward the exterior because this downward movement also causes each of the pins 241 fixed to the crown 24 to slide in a corresponding slot 251 of a finger 25. By pivoting toward the exterior, the fingers 25 insert into the interior groove 101 of the shroud 10, this preventing any relative upward translational movement of the UNS 2 in the fuel assembly 1, and thus locking the UNS 2 in place.

The lowering of the head 30 of the gripper 3 continues until the weight 24 abuts against the plug 23 (FIG. 6C).

The grip of the gripper 3 is then deactivated by pivoting the fingers 31 toward the interior (FIG. 6D). The gripper 3 may then be removed from the fuel assembly 1.

Lastly, the gripper 3 is raised, the UNS 2 being inserted and locked into the fuel assembly 1 by means of the fingers 25 inserted and held in the groove 101 of the shroud 10 (FIG. 6E). The weight of the weight 24 guarantees the UNS 2 is maintained and locked in the head 11 of the fuel assembly despite the ascending hydraulic thrust applied by the coolant in operation.

The steps used to unlock and extract the UNS 2 from the fuel assembly 1 will now be described in chronological order.

In the locked position, such as illustrated in FIG. 6E, the weight 24 and the plug 23 are in abutment and the columns 26 protrude from the weight 24. Provision is made for the height of the protrusion to be slightly smaller than the maximum relative axial movement between the weight 24 and the plug 23.

The handling gripper 3 is lowered until the translationally movable head 30 abuts against the columns 26.

After the weight 24 has been gripped by the pivoting fingers 31 of the gripper 3, i.e. the fingers inserted into the groove 240, it is possible to move the weight 24 translationally relative to the plug 23 and therefore to cause the locking fingers 25 to pivot toward the interior. The fingers 25 are made to pivot by the pins 241 sliding in the slots 251.

The fingers 25 are then extracted from the groove 101 of the shroud 10 and the UNS 2 is unlocked from the rest of the fuel assembly 1.

When the upper transverse plane of the columns 26 reaches level with the upper transverse plane of the weight 24, the translationally movable head 30 can no longer create a relative axial movement between the weight 24 and the plug 23.

Then only the upward translational movement of the gripper 3 then allows the extraction of the weight 24 to continue until the shoulder 242 of the bottom portion of the weight 24 abuts against the shoulder 231 of the top portion of the plug 23. The UNS 2 is then raised by the gripper 3 then extracted out of the fuel assembly 1.

A fuel assembly 1 according to the invention with its connection for locking/unlocking its UNS 2 as just described allows the functional specifications of a fourth-generation fast neutron nuclear reactor such as ASTRID to be met.

Other variants and improvements may be provided without however departing from the scope of the invention.

Thus, it is advantageously possible to measure the axial movement of the gripper 3 during the steps of inserting and of locking the UNS 2 in the fuel assembly 2 in order to guarantee that the targeted lock is operational.

Such as illustrated in FIGS. 5 to 6B, the various components of the UNS 2 and the locking components are designed to minimize pressure losses in the flow of sodium. This also easily allows the lock to be made safer, i.e. to guarantee the absence of any risk of ejection of the weight 24 during operation of the nuclear reactor.

It is possible for the extracting gripper 3 not to comprise a translationally movable part. Specifically, in the absence of seizure, raising the weight 24 with the gripper alone may allow the locking fingers 25 to be rotated and thus the UNS 2 to be unlocked.

As regards the actual handling of the fuel assembly 1 by its shroud 10, instead of holes 18 provision may be made for a continuous groove 19 in the interior wall of the shroud 10, as illustrated in FIG. 7. This continuous groove 19 is also suitable for interacting with the fingers 31 of a handling gripper having the same operational movement as the extracting gripper 3.

As regards the actual form of the UNS 2, instead of a sleeve 20 housing the blocks 21 of neutron absorbers, provision may be made for a cylindrical wrapper 27 housing a plurality of neutron absorber rods 28 that are arranged in the form of a bundle, as illustrated in FIGS. 8 to 8B. As may be best seen in FIG. 8, the lower end 270 of the support 27 again abuts against the supporting part 102, in the inserted and locked position of the UNS 2 in the fuel assembly 1.

In the illustrated examples, the wrapper 27 has a circular transverse cross-section, but it could have a different cross-section, for example a hexagonal cross-section inter alia.

One of the functions of the wrapper 27 is to protect the rods 28, in particular during the extraction of the UNS 2 from the rest of the fuel assembly 1. Instead of the wrapper 27, other wrapperless structures could however be envisioned, for example grids for holding the rods inter alia.

Instead of the columns 26, provision may be made for a ferrule 29 securely fastened to the plug 23 and arranged on the periphery of the weight 24. The upper end of the ferrule 29 is located level with the upper plane of the weight 24 in the unlocked position (FIG. 9A) and it protrudes in the unlocked position (FIG. 9B). The arrangement of the bearing ferrule 29 on the periphery of the weight 24 allows a maximum of space to be created at the center and on the periphery of the weight 24 and therefore pressure losses to be limited, thereby promoting the flow of sodium through the crown 24. Orifices 271, which are advantageously three in number and regularly distributed spaced apart by 120° from one another, are provided in the upper portion of the weight 24 (FIG. 8A). Furthermore, in order to allow the sodium to flow over the rods 28, vents (not shown) are integrated into the upper portion of the plug 23.

As regards the structures for holding the bundles of rods, various options that have been developed for the fuel assemblies and assemblies for controlling reactivity of SFRs may be envisioned. It is possible to envision a system of rails for supporting rods, in general in the bottom portion for the bundles of fissile rods of the fuel assemblies, and in general in the top portion for the assemblies for controlling the reactivity (suspended bundle). Next, in particular depending on the number of rings of rods and their diameter, provision may in particular be made for:
a cylindrical wrapper of circular cross-section associated with spacer wires, as shown in FIGS. 8 to 9B;
a central shaft connecting the supporting rails to one or more spacer grids located along the bundle of rods;
a toroidal ring deployed level with the plugs located at the other end with respect to the supporting rails.

### CITED REFERENCE

[1]: Text book “Réacteurs à neutrons rapides refroidis au sodium”—Les techniques de l'Ingénieur B 3 171

1. A fuel assembly for nuclear reactor, in particular for sodium-cooled SFR reactor, including:
a shroud of longitudinal axis intended to be inserted vertically into the diagrid of the core of the reactor, the shroud comprising a central section housing nuclear fuel rods and an upper section forming the head of the assembly housing an upper neutron shield (UNS) device including neutron absorbers,
means for reversibly locking with the shroud and;
a weight forming a section of the head of the UNS,
wherein said section are translationally movable with respect to the rest of the UNS over a given course,
wherein said locking means are configured so that the UNS and the shroud can be locked and unlocked by moving the weight along the longitudinal axis by means of a UNS-extracting gripper with the fingers of the gripper hooked into the weight and the rest of the UNS being in downward longitudinal abutment in the interior of the shroud.

2. The fuel assembly as claimed in claim 1, the head of the assembly furthermore including holes or a groove that is or are suitable for interacting with the fingers of a handling gripper in order to allow the assembly to be handled whether it is or is not equipped with its UNS, the gripper for handling the assembly having the same operating movement as that of the UNS-extracting gripper.

3. The fuel assembly as claimed in claim 1, wherein the UNS head includes a part forming a plug of the neutron absorbers of the UNS and supporting the locking means.

4. The fuel assembly as claimed in claim 1, the locking means consisting of fingers that are mounted so as to be able to pivot in a vertical plane.

5. The fuel assembly as claimed in claim 4, each of the fingers being mounted so as to be able to pivot about a pivot pin fastened to the plug.

6. The fuel assembly as claimed in claim 4, the weight including fixed pins that are each suitable for sliding in the interior of a slot in a pivoting finger, a vertical translational movement of the weight causing the pins to slide in the slots and thus the fingers to pivot.

7. The fuel assembly as claimed in claim 1, the weight including an interior groove into which the fingers of the UNS-extracting gripper may be hooked.

8. The fuel assembly as claimed in claim 1, the shroud including an interior groove into which the fingers of the locking means may insert to form an upper stop for the UNS.

9. (canceled)

10. The fuel assembly as claimed in claim 1, wherein the UNS includes one or more hollow columns that is or are fastened to the plug and that pass through the weight, the one or more columns being suitable for being brought to bear against a translationally movable part of the UNS-extracting gripper, in order to create an ascendant relative movement between the weight and the rest of the UNS during the unlocking operation.

11. The fuel assembly as claimed in claim 1, wherein the UNS includes a ferrule that is exterior to the plug, the ferrule being suitable for being brought to bear against a translationally movable part of the gripper in order to create an ascendant relative movement between the weight and the rest of the UNS during the unlocking operation.

12. (canceled)

13. The fuel assembly as claimed in claim 1, wherein the UNS includes a sleeve housing and supporting blocks of neutron absorber, and a plug fastened to the top of the sleeve.

14. The fuel assembly as claimed in claim 1, wherein the UNS includes a wrapper rods of neutron absorber, and a plug fastened to the top of the wrapper and supporting the rods.

15. The fuel assembly as claimed in claim 1, including a part fastened to the interior of the shroud, forming the lower axial longitudinal downward stop of the UNS.

16. The fuel assembly as claimed in claim 1, wherein the neutron absorbers placed in the UNS are chosen from boron carbide (B₄C), hafnium (Hf), hafnium diboride (HfB₂), titanium diboride (TiB₂), ferroboride (FeB), uranium dioxide (UO₂), the rare earths.

17. A method for handling a fuel assembly whether it is or is not equipped with its UNS as claimed in claim 1, wherein a handling gripper that is of the same type as, and preferably identical to, that used for the extraction of the UNS is used.

18. A method for equipping a new fuel assembly not equipped with a UNS, with an irradiated UNS extracted from an irradiated fuel assembly as claimed in claim 1.

19. The use of a fuel assembly as claimed in claim 1, in a fast neutron nuclear reactor.

20. The use as claimed in claim 19, the reactor being liquid-metal or gas-cooled, the liquid metal being chosen from sodium, lead or lead-bismuth.
